(19) United States
(12) Patent Application Publication
(10) Pub. No.: US 2025/0097106 A1
(43) Pub. Date: Mar. 20, 2025

(54) SERVICE-SPECIFIC CARBON EMISSION MONITORING AND MITIGATION

(71) Applicant: Cisco Technology, Inc., San Jose, CA (US)

(72) Inventors: Steven Barth, Delitzsch (DE); Guillaume Ladhuie, Ivry-Sur-Seine (FR)

(21) Appl. No.: 18/469,809

(22) Filed: Sep. 19, 2023

(51) Int. Cl. H04L 41/0833; H04L 41/0816; H04L 41/16; H04L 45/00

(52) U.S. Cl. CPC H04L 41/0833; H04L 41/0816; H04L 41/16; H04L 43/08; H04L 45/22

(57) ABSTRACT

A method, computer system, and computer program product are provided for mitigating carbon emissions. Data is obtained indicating an overall amount of power consumption for a plurality of nodes in a service provider network, wherein each node of the plurality of nodes is located in a different geographical location, and wherein the service provider network provides service to a plurality of service provider network users. A fraction of network traffic is determined that is handled by the plurality of nodes in the service provider network for serving a particular service provider network user. A service provider network user power consumption is determined for the particular service provider network user based on the fraction of network traffic and the overall amount of power consumption. An amount of emissions is determined resulting from generating electrical power to support the service provider network user power consumption for the particular service provider network user.

### TECHNICAL FIELD

The present disclosure relates generally to service provider networks, and more specifically, to service-specific carbon emission monitoring and mitigation in service provider networks.

### BACKGROUND

The generation of carbon emission occurs during the production, transportation, and usage of electricity, with fossil fuel-based sources contributing to the release of greenhouse gases into the atmosphere. In the context of telecommunication networks, the infrastructure that is associated with the operation and maintenance of network components uses electricity, and thus contributes toward carbon emissions. In particular, since electricity is continuously used to power network equipment such as data centers, cellular towers, routers, and switches, carbon emissions may only be avoided by obtaining electricity from renewable sources (e.g., solar, wind, etc.). Efforts to mitigate carbon emissions in this context include optimizing energy efficiency, transitioning to renewable energy sources, and implementing sustainable design practices throughout the lifecycle of network operations.

### BRIEF DESCRIPTION OF THE DRAWINGS

FIG. 1 is a block diagram of a network environment for monitoring and mitigating carbon emissions, according to an example embodiment.

FIG. 2 is a block diagram depicting a system for calculating carbon emissions, according to an example embodiment.

FIG. 3 is a diagram depicting a user interface, according to an example embodiment.

FIG. 4 is a diagram of a user interface displaying the per-service carbon emissions attributed to a node, according to an example embodiment.

FIG. 5 is a diagram depicting a user interface for a service provider network, according to an example embodiment.

FIG. 6 is a diagram depicting a user interface, according to an example embodiment.

FIG. 7 is a flow chart of a method of monitoring and mitigating carbon emissions, according to an example embodiment.

FIG. 8 is a flow chart of a method of training and applying a predictive model, according to an example embodiment.

FIG. 9 is a block diagram of a device that may be configured to perform operations relating to monitoring and/or mitigating carbon emissions, as presented herein.

### DETAILED DESCRIPTION

### Overview

According to one embodiment, techniques are provided for monitoring and mitigating carbon emissions. Data is obtained indicating an overall amount of power consumption for a plurality of nodes in a service provider network, wherein each node of the plurality of nodes is located in a different geographical location, and wherein the service provider network provides service to a plurality of service provider network users. A fraction of network traffic is determined that is handled by the plurality of nodes in the service provider network for serving a particular service provider network user. A service provider network user power consumption is determined for the particular service provider network user based on the fraction of network traffic and the overall amount of power consumption. An amount of emissions is determined resulting from generating electrical power to support the service provider network user power consumption for the particular service provider network user.

### Example Embodiments

Present embodiments relate to service provider networks, and more specifically, to service-specific carbon emission monitoring and mitigation in service provider networks. In a service provider network, one entity may be responsible for providing the infrastructure that is utilized by multiple service provider network users, each of whom may provide telecommunication, data centers, and other services to multiple end-users. For various reasons, it is desirable to track and report the volume of carbon that is emitted due to activity in a particular industry. In the context of service provider networks, carbon emissions may be monitored in order to report to regulatory agencies, to comply with regional requirements, or to obtain particular certifications.

The amount of electrical power that is utilized to power equipment can serve as a basis for quantifying carbon emissions. However, it may be difficult to ascertain how much carbon is emitted due to particular activities within a service provider network, as conventional approaches monitor energy consumption on an infrastructure level, such as per point of presence, per rack, or per device. Thus, conventional solutions cannot quantify carbon emissions for service provider network users. The problem of tracking carbon emissions is further compounded due to the fact that a service provider network may have a complex topology that includes a plurality of nodes situated in different geographical locations.

To address this problem, the embodiments presented herein provide an improved approach to monitoring carbon emissions in a manner that tracks emissions on a service provider network user basis. The share of a particular service provider network user's traffic in a node as compared to the overall amount of traffic handled by the node can be used to compute the amount of electrical power utilized by the particular service provider network user, and consequentially, the amount of carbon emitted. For example, if 25% of a node's total traffic corresponds to serving a particular service provider network user, then that service provider network user may be considered to utilize 25% of the total power consumed by that node, which can be converted into a volume of carbon emitted.

Thus, present embodiments improve the technical field of carbon-aware/sustainable energy management by providing a manner of monitoring and mitigating the carbon emissions associated with service provider network users. Carbon emissions can be monitored at a granularity level that enables each service provider network user's individual carbon emissions to be determined. Moreover, the nodes that constitute a particular traffic route for a service provider network user can be analyzed so that a different route (e.g., using different nodes) can be intelligently and automatically selected in order to reduce the amount of undesirable emissions (e.g., carbon emissions) produced to generate the electrical power to serve that traffic route. For example, if an alternative route is available that includes one or more nodes powered by renewable energy, traffic for a given service provider network user may be rerouted to that route, thereby reducing the volume of carbon emitted by the service provider network user. Thus, present embodiments provide the practical application of providing greater visibility of carbon emission in a service provider network while also reducing the amount of carbon that is emitted.

It should be noted that references throughout this specification to features, advantages, or similar language herein do not imply that all of the features and advantages that may be realized with the embodiments disclosed herein should be, or are in, any single embodiment. Rather, language referring to the features and advantages is understood to mean that a specific feature, advantage, or characteristic described in connection with an embodiment is included in at least one embodiment. Thus, discussion of the features, advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages will become more fully apparent from the following drawings, description and appended claims, or may be learned by the practice of embodiments as set forth hereinafter.

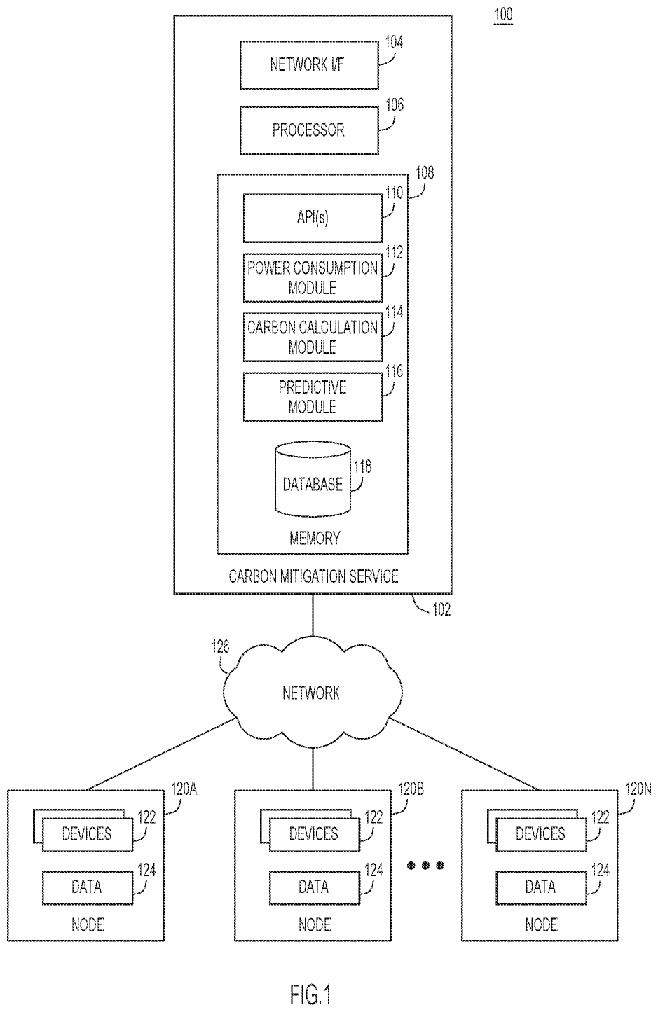

FIG. 1 is a block diagram in which a network environment 100 for monitoring and mitigating carbon emission, according to an example embodiment. As depicted, network environment 100 includes a carbon mitigation service 102 and a plurality of nodes 120A, 120B,-120N that are in communication via a network 126. It is to be understood that the functional division among components have been chosen for purposes of explaining various embodiments and is not to be construed as a limiting example. The plurality of nodes 120A-120N may be part of a service provider network that provides various networking services to a plurality of service provider network users.

Carbon mitigation service 102 includes a network interface (I/F) 104, at least one processor (computer processor) 106, memory 108 (which stores instructions for one or more application programming interfaces (APIs) 110, a power consumption module 112, a carbon calculation module 114, and a predictive module 116), and a database 118. In various embodiments, carbon mitigation service 102 may include a rack-mounted server, laptop, desktop, smartphone, tablet, or any other programmable electronic device capable of executing computer readable program instructions. Network interface 104 enables components of carbon mitigation service 102 to send and receive data over a network, such as network 126.

API(s) 110, power consumption module 112, carbon calculation module 114, and/or predictive module 116 may include one or more modules or units to perform various functions of the embodiments described below. API(s) 110, power consumption module 112, carbon calculation module 114, and/or predictive module 116 may be implemented by any combination of any quantity of software and/or hardware modules or units, and may reside within memory 108 of carbon mitigation service 102 for execution by a processor, such as processor 106.

Carbon mitigation service 102 may expose one or more APIs (e.g., API(s) 110) that enable carbon mitigation service 102 to obtain data from and/or provide data to nodes 120A-120N. These APIs 110 can utilize communication protocols, such as HTTP (Hypertext Transfer Protocol), WebSocket, or other appropriate protocols, to facilitate the transmission of data between carbon mitigation service 102 and nodes 120A-120N. In some embodiments, API(s) 110 may include one or more representational state transfer (REST) APIs, API(s) 110 may utilize a Representational State Transfer (REST) Configuration (RESTCONF) protocol, a remote procedure call (RPC) framework (e.g., gRPC), a gRPC Network Management Interface (gNMI) protocol, a Border Gateway Protocol (BGP), such as BGP with Link State (BGP-LS), and/or an Interior Gateway Protocol (IGP), such as IGP with Segment Routing (IGP+SR). It should be appreciated that APIs and protocols are provided by way of example, and any suitable APIs may be employed in order to obtain data from and/or provide data to nodes in a telecommunication network.

The data obtained by API(s) 110 may include data from nodes (e.g., nodes 120A-120N) relating to traffic and/or power consumption of devices (e.g., devices 122). The traffic can include overall throughput as well as per-user throughput. The per-user throughput can be represented an amount of data handled by a particular node for a particular user over an amount of time. The per-user throughput may be represented as a percentage of the overall traffic handled by a node. For example, if a user accounts for 25% of all traffic handled by a node over a given time period, that user's traffic data may indicate the 25% share of the traffic, or if raw data is obtained, then the per-user traffic share can be determined by dividing the user's traffic amount by the overall amount of traffic handled by a node. The traffic data and power consumption data may be time-series data, so that traffic can be correlated to power consumption at corresponding times. The power consumption data obtained from nodes may include a rate of energy consumed (i.e., a power value) and an amount of time over which the energy is consumed, or an amount of energy consumed. The energy that is measured can include any energy utilized by powered devices (e.g., devices 122) in nodes that handle network traffic of users. The per-device power consumption data may be obtained using model-driven telemetry.

Power consumption module 112 may analyze the data relating to power consumption of devices in combination with the network traffic data to identify per-user shares of power consumption. Power consumption module 112 may include logic for determining power consumption for a particular user of a service provider network, which may include individual services (e.g., virtual private networks (VPNs)) provided to the user. Power consumption module 112 may analyze a selected user's traffic data by comparing the user's traffic volume to the overall volume of traffic handled by each device in the data route. For each device, the user's traffic volume is divided by the overall traffic volume handled by that device to obtain a percentage indicating the fraction of traffic for which the user is responsible. Next, power consumption module 112 may determine the amount of power consumed by a given device for a given user by multiplying the fraction of traffic that is determined to account for the user's usage by the amount of power consumed by the device during a selected period. For example, if a particular user accounts for 50% of the traffic handled by a device during a select time period, and the device consumed 2 kW-h during that time period, then power consumption module 112 may determine that the particular user utilized 1 kW-h of energy (50%×2 kW-h=1 kW-h). Power consumption module 112 may accordingly determine the amount of power consumed by a specific user on a per-device level for each device that handles the user's traffic. Thus, a total amount of power consumption can be quantified for a user in a service provider network by summing the power consumption of each device handling traffic for the user.

Carbon calculation module 114 may determine an amount of carbon emissions that are associated with generating the power that is used to power devices in a service provider network. In particular, carbon calculation module 114 may obtain carbon intensity values for the electricity that is provided to each node 120A-120N; each carbon intensity value may indicate an amount of carbon dioxide (e.g., grams CO₂) that is released to produce an amount of the electricity. Thus, carbon intensity values may be in units of g CO₂/kWh. The carbon intensity values may be obtained as time-series data, as an electrical grid's carbon intensity may fluctuate over time due to how the electricity is generated. For example, power plant efficiencies may fluctuate, and the amount of power obtained from renewable sources may change (e.g., carbon intensity may decrease on a sunny day if solar power is utilized in part to meet electrical demand.) As each node 120A-120N may be located in a different geographical location, nodes 120A-120N may obtain electricity from different power grids and accordingly, each node 120A-120N may have its own carbon intensity value. Carbon calculation module 114 may determine the amount of carbon emissions that result from a given user's usage of a service provider network by multiplying the carbon intensity at each node by the user's power consumption at that node, and then summing the values of each node used by the user to obtain an overall amount of carbon dioxide that is emitted.

Predictive module 116 may include logic for analyzing power consumption data, user traffic data, and/or carbon intensity data in order to predict how much power will be consumed by a user of a service provider network and/or to predict how much carbon dioxide will be emitted as a result of a user's power consumption. In some embodiments, predictive module 116 includes a machine learning model that is trained using a corpus of historical data that includes user traffic values along with corresponding nodes, power consumption data, and carbon intensity data. The machine learning model may include a long short-term memory (LSTM) model, a convolutional neural network (CNN), a recurrent neural network (RNN), a transformer model that applies self- attention mechanisms, and/or any other model that is suitable for predicting future time-series data given historical time-series data. Predictive module 116 may include an energy-traffic predictor function that can predict the amount of power consumed by a user and/or the amount of carbon emitted by a user if the user's traffic is routed along a different set of nodes and/or if the user's traffic is throttled. Thus, predictive module 116 can determine whether a user's traffic can be rerouted to reduce the user's energy consumption and/or carbon emissions. In some embodiments, when predictive module 116 identifies a new route of nodes that would reduce the user's energy consumption and/or carbon emissions, the user's traffic is automatically rerouted along the new route. In some embodiments, if a user's energy consumption and/or carbon emissions are predicted to exceed a predetermined threshold value, the user's traffic may be temporarily throttled during the time when the energy consumption and/or carbon emissions are predicted to exceed the threshold value, thereby meeting a target value for energy consumption and/or carbon emissions.

Database 118 may include any non-volatile storage media known in the art. For example, database 118 can be implemented with a tape library, optical library, one or more independent hard disk drives, or multiple hard disk drives in a redundant array of independent disks (RAID). Similarly, data stored in database 118 may conform to any suitable storage architecture known in the art, such as a file, a relational database, an object-oriented database, and/or one or more tables. Database 118 may store time-series data including energy consumption data regarding devices 122 of nodes 120A-120N, per-user traffic data and overall traffic data of devices 122, carbon intensity data, and other data, including the specific nodes through which each user's traffic passes, the geographical locations of nodes (which may be used to determine carbon intensity values from network-accessible sources), and/or data that is output by predictive module 116.

Nodes 120A-120N may each include devices 122 for performing various networking related functions, and data 124 that is collected from those devices. Each node may be located in a facility or group of facilities that is geographically distinct from that of the other nodes. Nodes 120A-120N may form the infrastructure for a network in which various data is transmitted via devices 122, which can include routers, switches, hubs, servers, firewalls, load balancers, compute, storage, and/or other devices. Data 124 may include energy consumption data regarding devices 122, per-user traffic data, overall traffic data, and/or geographical data indicating the locations of nodes 120A-120N.

Network 126 may include a local area network (LAN), a wide area network (WAN) such as the Internet, or a combination of the two, and includes wired, wireless, or fiber optic connections. In general, network 126 can be any combination of connections and protocols known in the art that will support communications between carbon mitigation service 102 and nodes 120A-120N via their respective network interfaces in accordance with the described embodiments.

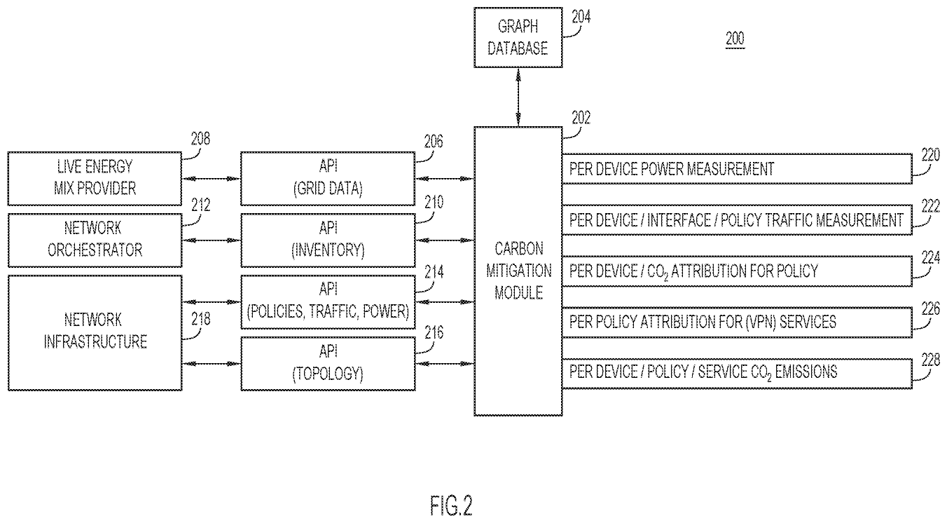

FIG. 2 is a block diagram depicting a system 200 for calculating carbon emissions, according to an example embodiment. As depicted, system 200 includes a carbon mitigation module 202, a graph database 204, and outputs (e.g., per-device power measurements) 220-228. Additionally, system 200 includes a plurality of APIs 206, 210, 214, and 216, which provide access to a live energy mix provider 208, a network orchestrator 212, and network infrastructure 218.

Carbon mitigation module 202 may correspond to one or more elements of network environment 100 (e.g., power consumption module 112, carbon calculation module 114, and/or predictive module 116, etc.), as depicted and described with reference to FIG. 1. In general, carbon mitigation module 202 may obtain data relating to network traffic, topology, and power consumption in order to calculate carbon emissions and determine carbon mitigation actions. API 206 may be configured to obtain grid data from a live energy mix provider 208, which can include carbon intensity values for one or more electrical grids. In some embodiments, API 206 includes a REST API that obtains carbon intensity values from one or more network-accessible locations. The carbon intensity values that are obtained are selected based on the geographical locations of nodes in the service provider network so that the appropriate carbon intensity values can be used for the power-consuming devices at each node. API 210 may be an API configured to access a network orchestrator (e.g., network orchestrator 212) in order to obtain inventory data indicating the devices that are in use at one or more nodes. In some embodiments, the inventory data indicates the particular devices used by a particular user of the service provider network, which may include an exhaustive list of devices such as routers, switches, servers, etc. In one embodiment, API 210 may be implemented using a RESTCONF protocol.

APIs 214 and 216 may obtain data from network infrastructure 218. API 214 may obtain data including policy data, traffic data, and power data, which can indicate segment routing policies, a service provider network user's volume of traffic being handled by devices, and power consumption of devices, respectively. In some embodiments, API 214 employs an RPC framework, such as gRPC or gNMI. API 216 may access network infrastructure 218 to collect topology data of network infrastructure 218, which can indicate the geographical locations of devices as well as how data is routed through devices (e.g., the path of each data route). API 216 may utilize a Border Gateway Protocol (e.g., BGP), such as BGP-LS, and/or an Interior Gateway Protocol (IGP), such as IGP+SR. API 216 can obtain the network topology by accessing any router in the network (e.g., using BGP-LS).

Carbon mitigation module 202 may store the data obtained by the APIs to graph database 204, which can store the data as nodes, edges connecting the nodes, and attributes of nodes and/or edges. Carbon mitigation module 202 may analyze the data to generate the outputs, which include per-device power measurements 220, per-device/interface/policy traffic measurements 222, per-device power or carbon dioxide attribution for a policy 224, per-policy attribution for services (e.g., VPN services) 226, and/or per-device/policy/service carbon dioxide emissions 228. In some embodiments, power and/or carbon emissions are calculated for individual segment routing polices using a segment identifier for each segment in a route to determine all nodes that are affected by a segment routing policy; using traffic counters for those nodes, the ratio of the segment routing policy's traffic to the overall node traffic can be determined, and accounting the same ratio to power and carbon emissions for each affected node can be used to determine power consumption and/or carbon emissions for a particular segment routing policy for each node, which can be summed to determine the overall power consumption and/or carbon emissions for the service.

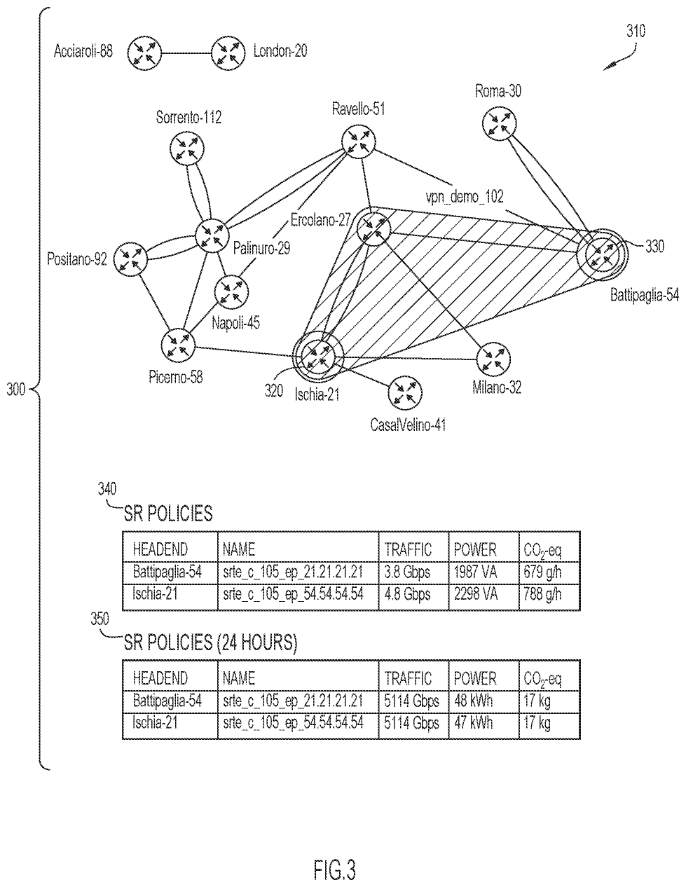

FIG. 3 is a diagram depicting a user interface 300, according to an example embodiment. As depicted, user interface 300 includes a node map 310 that includes a plurality of nodes (e.g., nodes 320 and 330 as well as additional nodes), and tables 340 and 350 presenting data relating to traffic, power consumption, and carbon emission for a particular policy (e.g., “SR Policies”). As depicted, two particular nodes, node 320 (“Ischia-21”) and node 330 (“Battipaglia-54”), are selected for analysis, and data regarding each node is presented at tables 340 and 350.

Table 340 may present an instantaneous view of traffic, power consumption, and carbon emission data for each of nodes 320 and 330, which is calculated according to the embodiments presented herein. As depicted, for the selected policy, node 330 (“Battipaglia-54”) has a traffic value of 3.8 Gbps, power consumption of 1987 VA, and a carbon dioxide-equivalent emission of 679 g/h. Likewise, node 320 (“Ischia-21”) has a traffic value of 4.8 Gbps, power consumption of 2298 VA, and a carbon dioxide-equivalent emission of 788 g/h.

Table 350 shows values for traffic, power consumption, and carbon emission collected over a twenty-four hour time window. Thus, the values in table 350 are not instantaneous values per unit time, but rather, total values over the time window. For the selected policy, node 320 (“Ischia-21”) handled 5114 GB of traffic, which consumed 47 kWH of energy that corresponds to an emission of 17 kg of CO₂-eq. and node 330 handled 5114 GB of traffic, which consumed 48 kWh of energy that corresponds to an emission of 17 kg of CO₂-eq.

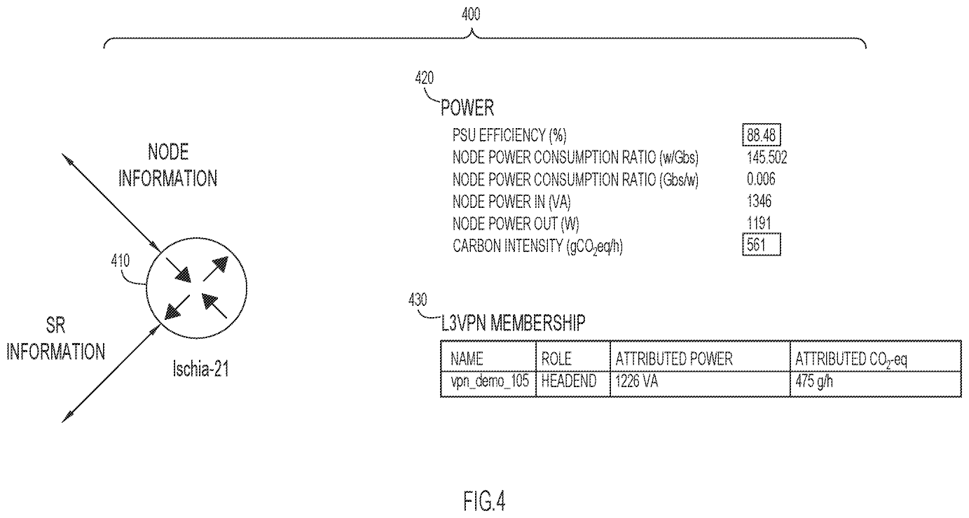

FIG. 4 is a diagram of a user interface 400 displaying the per-service carbon emission attributed to a node, according to an example embodiment. As depicted, user interface 400 includes a node 410 (“Ischia-21”), and tables 420 and 430. Node 410 provides node information and segment routing information to a system (e.g., carbon mitigation service 102, as depicted and described with reference to FIG. 1) in order to obtain per-service carbon emissions and power consumption of the selected node 410. Table 420 presents power consumption and carbon emission, including power supply unit (PSU) efficiency for the device, the node's power consumption ratio (in units of W/Gbps and Gbps/W), power in (in units of VA), power out (in units of W), and a carbon intensity for the electricity supplied to node 410 (in units of gCO₂-eq/h). Table 430 displays the attributed power to the node for a particular service (“L3VPN Membership”) based on that service's traffic fraction at node 410, as well as an attributed CO₂-eq (in units of g/h), which is determined by multiplying the carbon intensity by the fraction of traffic at node 410 that corresponds to the service's traffic proportion.

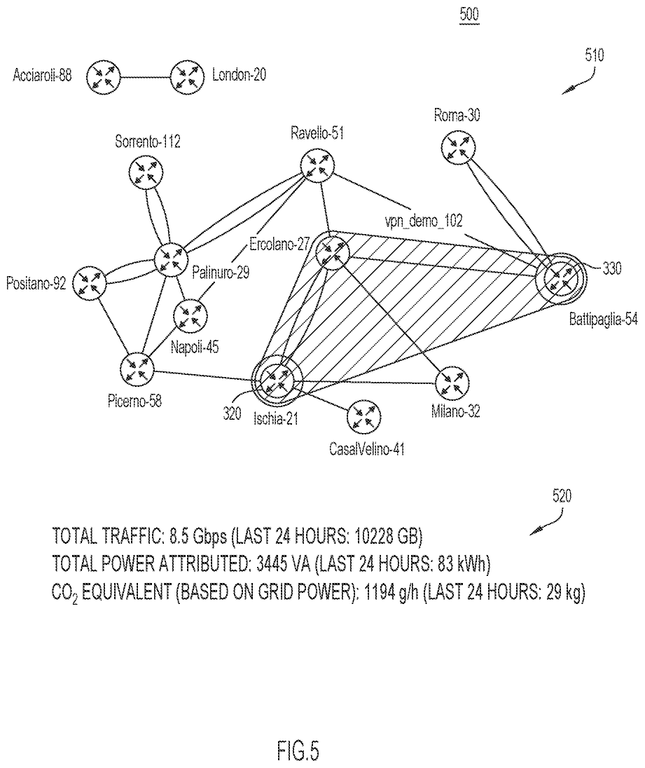

FIG. 5 is a diagram depicting a user interface 500 of a service provider network, according to an example embodiment. As depicted, user interface 500 displays a service provider network 510 comprising a plurality of nodes, and a table 520 presenting traffic, power consumption, and carbon emission data for a user of service provider network 510. The values in table 520 may correspond to a user's total usage for each value, with total instantaneous or average traffic equaling 8 Gbps (10,228 GB over a twenty-four hour window), total power attributed as 3,445 VA (83 kWh over a twenty-four hour window), and total carbon dioxide equivalent emissions of 1194 g/h (29 kg over a twenty-four hour window).

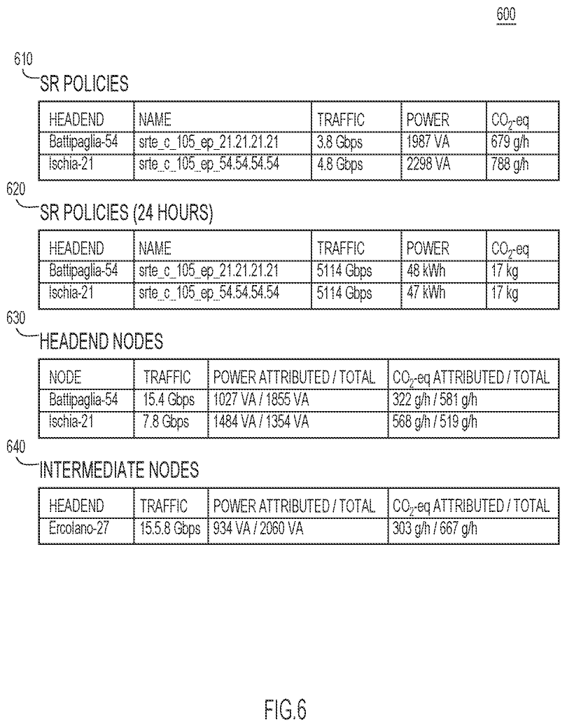

With reference to FIG. 6, a diagram depicts a user interface 600, according to an example embodiment. The data presented in user interface 600 may correspond to service provider network 510 as depicted and described in further detail with reference to FIG. 5. As depicted, user interface 600 includes a table 610 presenting instantaneous or average traffic, power consumption, and carbon emissions for a service (“SR Policies”). Table 620 presents total traffic, power consumption, and carbon emissions for the same service over a twenty-four hour period. Table 630 presents instantaneous or average traffic, power consumption, and carbon emissions at headend nodes (“Battipaglia-54” and “Ischia-21”), and table 640 presents instantaneous or average traffic, power consumption, and carbon emissions at intermediate nodes (“Ercolano-27”) between the headend nodes along the route. Thus, user interface 600 presents to a user a visualization showing traffic, power consumption, and carbon emissions at various levels of granularity, including instantaneous or average values, twenty-four hour total values, and per-node values for headend nodes and intermediate nodes.

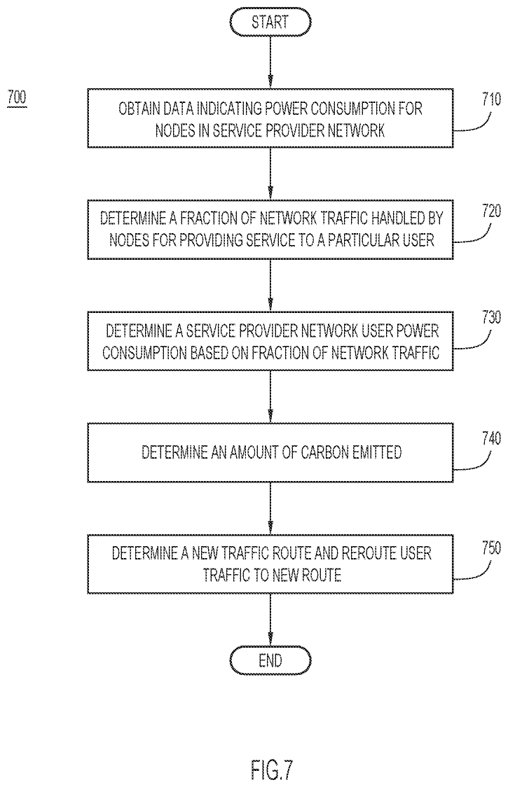

FIG. 7 is a flow chart of a method 700 of monitoring and mitigating carbon emissions, according to an example embodiment.

Data indicating power consumption for nodes in a service provider network is obtained at operation 710. The data may include a rate of power consumption and/or an overall amount of power consumed by one or more devices at each node. In some embodiments, instantaneous power data may be obtained, and overall energy consumption can be determined by integrating these values over time, which can be performed using an estimation method such as Riemann sums.

A fraction of network traffic handled by the nodes for providing service to a particular user is determined at operation 720. Traffic data may be obtained from each node indicating a user's traffic amount (e.g., in units of Gb, Gbps, etc.) as well as the total traffic amount handled by that node corresponding to the same time period as the user's traffic. The user's traffic amount can be divided by the total traffic amount to determine the fraction of traffic that is used to provide service to the user. Similarly, per-node values for a fraction of traffic can be determined for other users, and/or a fraction of traffic can be determined for a particular service or set of services corresponding to a user or multiple users. In various embodiments, the subset of traffic that is selected to determine the fraction of network traffic can correspond to that of a single user, a group of users, an entity that in turn provides service to a plurality of end-users, a particular service (e.g., a VPN), and the like. Traffic data may be obtained using model-driven telemetry, and can be selected based on having a same segment routing policy color (i.e., a numerical value that indicates that two or more policies utilize the same node pairs). A segment identifier list can indicate a set of traffic that corresponds to a same user/user group/entity, and the traffic data may be obtained from traffic counters provided at each node.

A service provider network user power consumption is determined based on the fraction of network traffic at operation 730. For a selected service provider network user, the power consumption is determined on a per-node basis by multiplying the user's fraction of traffic at that node by the amount of power consumed by devices handling the traffic at that node. The user's power consumption may be determined based on instantaneous values (e.g., in units of kW) or total energy consumed over a time period (e.g., in units of kWh). In some embodiments, total energy consumption can be determined by integrating time-series power values, which can be estimated using Riemann sums or other techniques.

An amount of carbon emitted is determined at operation 740. The power intensity values at each node may be determined by accessing energy grid data; each power intensity value may indicate a volume of carbon dioxide emitted as a result of generating a given unit of energy. Thus, by multiplying the energy consumption of each node by the corresponding power intensity for the electrical power provided to that node, an amount of carbon emitted can be determined, which can be represented in units of carbon per time (e.g., g/h) or a total mass (e.g., kg) over a given time span.

A new traffic route is determined and user traffic is rerouted to the new route at operation 750. A predictive model can be applied to calculate carbon emission volumes associated with a user's traffic following one or more different routes (e.g., involving at least one different node than the current route). If a new traffic route can be identified that would result in reducing the amount of carbon that is emitted, the user's traffic may be rerouted along the new route. Additionally or alternatively, user traffic can be throttled to satisfy a carbon emission threshold, and/or non-critical user traffic can be rescheduled for a time period that is associated with lower carbon emissions (e.g., during a sunny day when an electrical grid has a lower carbon intensity due to an increase in solar panel output).

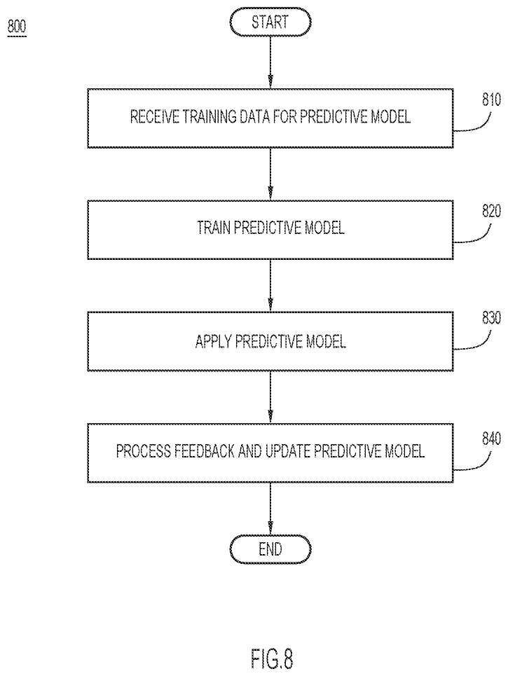

FIG. 8 is a flow chart of a method 800 of training and applying a predictive model, according to an example embodiment.

Training data is received for the predictive model at operation 810. The training data may include examples of various traffic loads being routed across various routes in a service provider network, which can be labeled with respect to the identity of each user for whom each service is provided, as well as the amount of energy/power consumed and/or the amount of carbon emitted as a result of generating the electricity to provide power for the devices handling the traffic. the training data may also be labeled with respect to time for each example value (e.g., the training data may be in a time-series format). The predictive model may include a machine learning model; in some embodiments, the machine learning model is configured to predict future time-series data given a set of time-series training data.

The predictive model is trained at operation 820. The training data may be used to train the predictive model until the predictive model attains a desired level of accuracy. In order to test the model, some of the training data may be reserved as testing data to measure how accurately the model can predict an amount of energy/power consumed and/or amount of carbon emitted based on a set of traffic flows in a service provider network.

The predictive model is applied at operation 830. Once the predictive model reaches a desired level of accuracy, the predictive model may be used to predict how the amount of energy/power consumed and/or the amount of carbon emitted for a service provider network would change if one or more sets of traffic each belonging to a same user/group of users/entity are rerouted to utilize a different set of nodes. Thus, the predictive model can identify when rerouting a service provider network user's traffic would result in lowering the amount of energy/power consumed and therefore, the amount of carbon emitted. These predictions can be practically applied by automatically rerouting user traffic when a new route is identified that corresponds to lower carbon emissions. The predictive model may transmit instructions to a device or service of the service provider network (e.g., an orchestrator, controller, router, etc.) to cause the traffic to be rerouted to the new route.

Feedback is processed and the predictive model is updated at operation 840. When traffic is rerouted based on application of the predictive model, the resulting changes to a service provider network can be measured as feedback and provided to the training data to continuously expand the training data over time, thereby improving the accuracy of the predictive model. The predictive model may thus be retrained periodically in order to update the predictive model with a more accurate model.

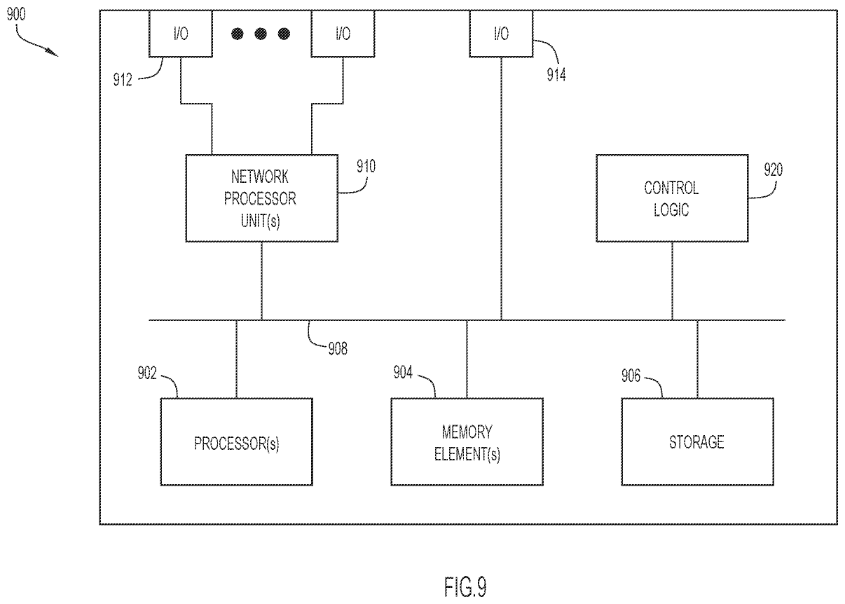

Referring now to FIG. 9, FIG. 9 illustrates a hardware block diagram of a computing device 900 that may perform functions associated with operations discussed herein in connection with the techniques depicted in FIGS. 1-8. In at least one embodiment, the computing device 900 may include one or more processor(s) 902, one or more memory element(s) 904, storage 906, a bus 908, one or more network processor unit(s) 910 interconnected with one or more network input/output (I/O) interface(s) 912, one or more I/O 914, and control logic 920. In various embodiments, instructions associated with logic for computing device 900 can overlap in any manner and are not limited to the specific allocation of instructions and/or operations described herein.

In at least one embodiment, processor(s) 902 is/are at least one hardware processor configured to execute various tasks, operations and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with memory element(s) 904 (or vice versa), or can overlap/exist in any other suitable manner.

In at least one embodiment, bus 908 can be configured as an interface that enables one or more elements of computing device 900 to communicate in order to exchange information and/or data. Bus 908 can be implemented with any architecture designed for passing control, data and/or information between processors, memory elements/storage, peripheral devices, and/or any other hardware and/or software components that may be configured for computing device 900. In at least one embodiment, bus 908 may be implemented as a fast kernel-hosted interconnect, potentially using shared memory between processes (e.g., logic), which can enable efficient communication paths between the processes.

In various embodiments, network processor unit(s) 910 may enable communication between computing device 900 and other systems, entities, etc., via network I/O interface(s) 912 (wired and/or wireless) to facilitate operations discussed for various embodiments described herein. In various embodiments, network processor unit(s) 910 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 900 and other systems, entities, etc. to facilitate operations for various embodiments described herein. In various embodiments, network I/O interface(s) 912 can be configured as one or more Ethernet port(s), Fibre Channel ports, any other I/O port(s), and/or antenna(s)/antenna array(s) now known or hereafter developed. Thus, the network processor unit(s) 910 and/or network I/O interface(s) 912 may include suitable interfaces for receiving, transmitting, and/or otherwise communicating data and/or information in a network environment.

I/O 914 allow for input and output of data and/or information with other entities that may be connected to computing device 900. For example, I/O 914 may provide a connection to external devices such as a keyboard, keypad, mouse, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 920 can include instructions that, when executed, cause processor(s) 902 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 904 and/or storage 906 can store data, software, code, instructions (E.g., processor instructions), logic, parameters, combinations thereof, and/or the like used for operations described herein. This includes memory element(s) 904 and/or storage 906 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 602.11 (e.g., Wi-Fi®/Wi-Fi6®), IEEE 602.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In some aspects, the techniques described herein relate to a computer-implemented method including: obtaining data indicating an overall amount of power consumption for a plurality of nodes in a service provider network, wherein each node of the plurality of nodes is located in a different geographical location, and wherein the service provider network provides service to a plurality of service provider network users; determining a fraction of network traffic that is handled by the plurality of nodes in the service provider network for serving a particular service provider network user; determining a service provider network user power consumption for the particular service provider network user based on the fraction of network traffic and the overall amount of power consumption; and determining an amount of emissions resulting from generating electrical power to support the service provider network user power consumption for the particular service provider network user.

In some aspects, the techniques described herein relate to a computer-implemented method, further including: determining a new traffic route for the network traffic of the particular service provider network user, wherein the new traffic route includes at least one different node compared to a current route of the network traffic, and wherein the new traffic route is associated with a lower amount of emissions; and transmitting an instruction to cause the network traffic of the particular service provider network user to follow the new traffic route.

In some aspects, the techniques described herein relate to a computer-implemented method, wherein the new traffic route is determined using a machine learning model.

In some aspects, the techniques described herein relate to a computer-implemented method, wherein the amount of emissions is determined based on a product of the service provider network user power consumption at each node and a carbon intensity associated with providing power to each node.

In some aspects, the techniques described herein relate to a computer-implemented method, wherein the carbon intensity associated with providing power to each node is determined according to a geographical location of each node.

In some aspects, the techniques described herein relate to a computer-implemented method, further including: transmitting an instruction to cause the network traffic of the particular service provider network user to be throttled to reduce the amount of emissions by a particular amount.

In some aspects, the techniques described herein relate to a computer-implemented method, wherein the amount of emissions is determined on a hop-by-hop basis based on an amount of power consumption at each node and based on measured traffic values for the particular service provider network user at each node.

In some aspects, the techniques described herein relate to a system including: one or more computer processors; one or more computer readable storage media; and program instructions stored on the one or more computer readable storage media for execution by at least one of the one or more computer processors, the program instructions including instructions to: obtain data indicating an overall amount of power consumption for a plurality of nodes in a service provider network, wherein each node of the plurality of nodes is located in a different geographical location, and wherein the service provider network provides service to a plurality of service provider network users; determine a fraction of network traffic that is handled by the plurality of nodes in the service provider network for serving a particular service provider network user; determine a service provider network user power consumption for the particular service provider network user based on the fraction of network traffic and the overall amount of power consumption; and determine an amount of emissions resulting from generating electrical power to support the service provider network user power consumption for the particular service provider network user.

In some aspects, the techniques described herein relate to a system, wherein the program instructions further include instructions to: determine a new traffic route for the network traffic of the particular service provider network user, wherein the new traffic route includes at least one different node compared to a current route of the network traffic, and wherein the new traffic route is associated with a lower amount of emissions; and transmit an instruction to cause the network traffic of the particular service provider network user to follow the new traffic route.

In some aspects, the techniques described herein relate to a system, wherein the new traffic route is determined using a machine learning model.

In some aspects, the techniques described herein relate to a system, wherein the amount of emissions is determined based on a product of the service provider network user power consumption at each node and a carbon intensity associated with providing power to each node.

In some aspects, the techniques described herein relate to a system, wherein the carbon intensity associated with providing power to each node is determined according to a geographical location of each node.

In some aspects, the techniques described herein relate to a system, wherein the program instructions further include instructions to: transmit an instruction to cause the network traffic of the particular service provider network user to be throttled to reduce the amount of emissions by a particular amount.

In some aspects, the techniques described herein relate to a system, wherein the amount of emissions is determined on a hop-by-hop basis based on an amount of power consumption at each node and based on measured traffic values for the particular service provider network user at each node.

In some aspects, the techniques described herein relate to one or more non-transitory computer readable storage media having program instructions embodied therewith, the program instructions executable by a computer to cause the computer to perform operations including: obtaining data indicating an overall amount of power consumption for a plurality of nodes in a service provider network, wherein each node of the plurality of nodes is located in a different geographical location, and wherein the service provider network provides service to a plurality of service provider network users; determining a fraction of network traffic that is handled by the plurality of nodes in the service provider network for serving a particular service provider network user; determining a service provider network user power consumption for the particular service provider network user based on the fraction of network traffic and the overall amount of power consumption; and determining an amount of emissions resulting from generating electrical power to support the service provider network user power consumption for the particular service provider network user.

In some aspects, the techniques described herein relate to one or more non-transitory computer readable storage media, wherein the program instructions further cause the computer to: determine a new traffic route for the network traffic of the particular service provider network user, wherein the new traffic route includes at least one different node compared to a current route of the network traffic, and wherein the new traffic route is associated with a lower amount of emissions; and transmit an instruction to cause the network traffic of the particular service provider network user to follow the new traffic route.

In some aspects, the techniques described herein relate to one or more non-transitory computer readable storage media, wherein the new traffic route is determined using a machine learning model.

In some aspects, the techniques described herein relate to one or more non-transitory computer readable storage media, wherein the amount of emissions is determined based on a product of the service provider network user power consumption at each node and a carbon intensity associated with providing power to each node.

In some aspects, the techniques described herein relate to one or more non-transitory computer readable storage media, wherein the carbon intensity associated with providing power to each node is determined according to a geographical location of each node.

In some aspects, the techniques described herein relate to one or more non-transitory computer readable storage media, wherein the program instructions further cause the computer to: transmit an instruction to cause the network traffic of the particular service provider network user to be throttled to reduce the amount of emissions by a particular amount.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
obtaining data indicating an overall amount of power consumption for a plurality of nodes in a service provider network, wherein each node of the plurality of nodes is located in a different geographical location, and wherein the service provider network provides service to a plurality of service provider network users;
determining a fraction of network traffic that is handled by the plurality of nodes in the service provider network for serving a particular service provider network user;
determining a service provider network user power consumption for the particular service provider network user based on the fraction of network traffic and the overall amount of power consumption; and
determining an amount of emissions resulting from generating electrical power to support the service provider network user power consumption for the particular service provider network user.

2. The computer-implemented method of claim 1, further comprising:
determining a new traffic route for the network traffic of the particular service provider network user, wherein the new traffic route includes at least one different node compared to a current route of the network traffic, and wherein the new traffic route is associated with a lower amount of emissions; and
transmitting an instruction to cause the network traffic of the particular service provider network user to follow the new traffic route.

3. The computer-implemented method of claim 2, wherein the new traffic route is determined using a machine learning model.

4. The computer-implemented method of claim 1, wherein the amount of emissions is determined based on a product of the service provider network user power consumption at each node and a carbon intensity associated with providing power to each node.

5. The computer-implemented method of claim 4, wherein the carbon intensity associated with providing power to each node is determined according to a geographical location of each node.

6. The computer-implemented method of claim 1, further comprising:
transmitting an instruction to cause the network traffic of the particular service provider network user to be throttled to reduce the amount of emissions by a particular amount.

7. The computer-implemented method of claim 1, wherein the amount of emissions is determined on a hop-by-hop basis based on an amount of power consumption at each node and based on measured traffic values for the particular service provider network user at each node.

8. A system comprising:
one or more computer processors;
one or more computer readable storage media; and
program instructions stored on the one or more computer readable storage media for execution by at least one of the one or more computer processors, the program instructions comprising instructions to:
obtain data indicating an overall amount of power consumption for a plurality of nodes in a service provider network, wherein each node of the plurality of nodes is located in a different geographical location, and wherein the service provider network provides service to a plurality of service provider network users;
determine a fraction of network traffic that is handled by the plurality of nodes in the service provider network for serving a particular service provider network user;
determine a service provider network user power consumption for the particular service provider network user based on the fraction of network traffic and the overall amount of power consumption; and
determine an amount of emissions resulting from generating electrical power to support the service provider network user power consumption for the particular service provider network user.

9. The system of claim 8, wherein the program instructions further comprise instructions to:
determine a new traffic route for the network traffic of the particular service provider network user, wherein the new traffic route includes at least one different node compared to a current route of the network traffic, and wherein the new traffic route is associated with a lower amount of emissions; and
transmit an instruction to cause the network traffic of the particular service provider network user to follow the new traffic route.

10. The system of claim 9, wherein the new traffic route is determined using a machine learning model.

11. The system of claim 8, wherein the amount of emissions is determined based on a product of the service provider network user power consumption at each node and a carbon intensity associated with providing power to each node.

12. The system of claim 11, wherein the carbon intensity associated with providing power to each node is determined according to a geographical location of each node.

13. The system of claim 8, wherein the program instructions further comprise instructions to:
transmit an instruction to cause the network traffic of the particular service provider network user to be throttled to reduce the amount of emissions by a particular amount.

14. The system of claim 8, wherein the amount of emissions is determined on a hop-by-hop basis based on an amount of power consumption at each node and based on measured traffic values for the particular service provider network user at each node.

15. One or more non-transitory computer readable storage media having program instructions embodied therewith, the program instructions executable by a computer to cause the computer to perform operations including:
obtaining data indicating an overall amount of power consumption for a plurality of nodes in a service provider network, wherein each node of the plurality of nodes is located in a different geographical location, and wherein the service provider network provides service to a plurality of service provider network users;
determining a fraction of network traffic that is handled by the plurality of nodes in the service provider network for serving a particular service provider network user;
determining a service provider network user power consumption for the particular service provider network user based on the fraction of network traffic and the overall amount of power consumption; and
determining an amount of emissions resulting from generating electrical power to support the service provider network user power consumption for the particular service provider network user.

16. The one or more non-transitory computer readable storage media of claim 15, wherein the program instructions further cause the computer to:
determine a new traffic route for the network traffic of the particular service provider network user, wherein the new traffic route includes at least one different node compared to a current route of the network traffic, and wherein the new traffic route is associated with a lower amount of emissions; and
transmit an instruction to cause the network traffic of the particular service provider network user to follow the new traffic route.

17. The one or more non-transitory computer readable storage media of claim 16, wherein the new traffic route is determined using a machine learning model.

18. The one or more non-transitory computer readable storage media of claim 15, wherein the amount of emissions is determined based on a product of the service provider network user power consumption at each node and a carbon intensity associated with providing power to each node.

19. The one or more non-transitory computer readable storage media of claim 18, wherein the carbon intensity associated with providing power to each node is determined according to a geographical location of each node.

20. The one or more non-transitory computer readable storage media of claim 15, wherein the program instructions further cause the computer to:
transmit an instruction to cause the network traffic of the particular service provider network user to be throttled to reduce the amount of emissions by a particular amount.
